(19) United States
(12) Patent Application Publication
(10) Pub. No.: US 2013/0153144 A1
(43) Pub. Date: Jun. 20, 2013

(54) MULTIPLE USE PRECISION EXTRACTABLE TOOLING

(71) Applicants: Michael Tupper, Lafayette, CO (US); Rory Barrett, Erie, CO (US); Larry G. Adams, Thornton, CO (US); Robert Taylor, Superior, CO (US); Dana Turse, Broomfield, CO (US)

(72) Inventors: Michael Tupper, Lafayette, CO (US); Rory Barrett, Erie, CO (US); Larry G. Adams, Thornton, CO (US); Robert Taylor, Superior, CO (US); Dana Turse, Broomfield, CO (US)

(73) Assignee: Composite Technology Development, Inc., Lafayette, CO (US)

(21) Appl. No.: 13/330,232

(22) Filed: Dec. 19, 2011

(51) Int. Cl. B32B 37/10

(52) U.S. Cl. 156/307.1; 156/349

(57) ABSTRACT

Embodiments of the invention are directed toward extractable tooling devices for composite structure manufacturing. An extractable tool, according to some embodiments of the invention, can include a rigid core, one or more foam blocks, an elastic membrane, and a nozzle. The foam blocks can be shaped to provide a mold of the composite structure being manufactured. This mold may require the extractable tool to be trapped by the composite structure after manufacture. Use of the foams can allow the extractable tool to shrink in at least one dimension in order to extract the tool from the trapped configuration.

### BACKGROUND

Composite materials hold great promise to provide weight and energy savings for high performance applications in aircraft structures, wind turbine and tidal turbine blades, marine propeller blades, spacecraft structures, and automobiles. These applications, and many others, require stiff, mass minimized structures that are optimized with complex skins, stringers, spars and ribs to provide global stiffness, local stiffness, and sufficient strength at the lowest reasonable cost. These highly optimized designs are trending towards the co-curing of multiple complex components at the same time to produce a “unitized” composite structure. The use of unitized structures allows for very large complex composite structures to be fabricated in a single manufacturing process. This practice has many advantages, including the reduction in the number of adhesive bonding steps, stronger bonds, a significant reduction in part-count, and a decrease in post-cure attachment of parts. Many designs can involve multiple “trapped” shapes, or areas in which a mold is effectively trapped within the part after cure. The tooling required for this type of fabrication has become increasingly complex and costly, such that tooling is the single highest cost item in many composite designs.

### BRIEF SUMMARY

Embodiments of the invention are directed toward extractable tooling devices for composite structure manufacturing. An extractable tool, according to some embodiments of the invention, can include a rigid core, one or more foam blocks, which may be shape a memory polymer foam, an elastic membrane, and a nozzle. The foam blocks can be shaped to provide a mold of the composite structure being manufactured. This mold may require the extractable tool to be trapped by the composite structure after manufacture. Use of the foams can allow the extractable tool to shrink in at least one dimension in order to extract the tool from the trapped configuration. Furthermore, the invention can allow for ‘out of autoclave curing’ of composite structures, as the pressure applied internally, within the tool during cure can be used to provide for appropriate consolidation of the reinforcing fibers within the composite laminate, much in the manner that pressure in an autoclave is used to consolidate a composite laminate.

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

### BRIEF DESCRIPTION OF THE DRAWINGS

Illustrative embodiments of the present invention are described in detail below with reference to the following figures.

FIG. 1 shows an example of an extractable tool according to some embodiments of the invention.

FIGS. 2A, 2B and 2C show side views of composite layers being laid up conformally with an extractable tool according to some embodiments of the invention.

FIGS. 3A, 3B, 3C, and 3D show photographs of an extractable tool being extracted from a composite structure according to some embodiments of the invention.

FIGS. 4A, 4B and 4C show three extractable tools being used to lay-up two composite I-beam structures according to some embodiments of the invention.

FIG. 5 is a flowchart of a process for using an extractable tool according to some embodiments of the invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Like numerals within the drawings and mentioned herein represent substantially identical structural elements. Each example is provided by way of explanation, and not as a limitation. For instance, features illustrated or described as part of one embodiment may be used on another embodiment to yield a further embodiment. Thus, it is intended that this disclosure includes modifications and variations.

Generally speaking embodiments of the invention include devices, apparatus, and methods for tooling for the fabrication of composite parts with trapped tooling conditions. In some embodiments, a Multiple Use Precision Extractable Tooling (MUPET) technology is disclosed using foams; for example, shape memory polymer (SMP) foams. SMP foams can include, for example, TEMBO® shape memory polymer foams developed by Composite Technology Development Inc., in Lafayette, Colo. Foam materials can be machined to produce shaped, high precision trapped tools that can be readily extracted from a finished composite part. The use of extractable tools may provide composite manufacturers with the capability to efficiently produce large, complex composites at costs much lower than with traditional tooling.

Foam extractable tools can enable the cost-effective fabrication of structurally and weight-efficient “unitized” composite structures that include trapped tooling conditions. Trapped tooling can be a challenge because the tool is positioned within a concave structure, under an overhang, etc. Embodiments of the invention provide for a tool that can shrink in a direction transverse to the removal direction. Embodiments of the invention can be attractive to commercial composites manufacturers due to their simplicity of use, attainable precision, robustness, reusability, and cost effectiveness. Embodiments of the invention can also provide an enabling step for the low-cost manufacture of complete aircraft fuselages, walls, wind turbine blades, automotive bodies, etc. in a single manufacturing step.

The use of foam extractable tools can offer many performance benefits over existing extractable tooling technologies, including low cost, high structural stiffness during composite lay-up, and large achievable reductions in volume. Foams can have a high rigidity at temperatures below the glass transition temperature of the foam. Such rigidity can be used to support composite structures during a lay-up process prior to cure. Foams can also be useful because of their high volume change characteristics when subjected to temperatures near or above the glass transition temperature. This volume change can be leveraged to allow for tooling to be extracted from a trapped position.

In some embodiments, a low density, open-celled foam can be produced in blocks and can be precisely machined to complex geometries, similar to conventional tooling materials. These complex geometries can include a trapped configuration. A trapped configuration can include geometries that are the complement or mold of a composite structure that, when formed, traps the tool within the composite structure. These geometries can include overhangs, convex shape or shapes, female portions, trapped shapes, etc.

Foam tooling can be extremely light weight, robust, and can support significant lay-up loads. Once the composite has been cured, the tool can be heated to temperatures near or above the glass transition temperature of the foam, at which point the tool can be deformed as needed for extraction. The foam structure can allow for higher levels of deformation and volume reduction than other types of materials, thereby allowing the tool to be easily extracted from tortuous paths or small openings. Foams, such as shape memory foams (SMP), are capable of precisely recovering their shape and thus can be used repeatedly in the manufacture of composite parts.

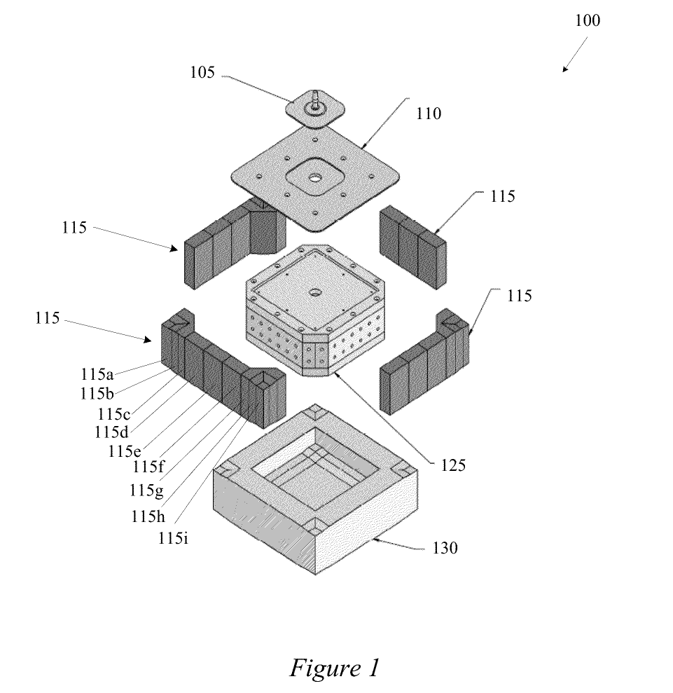

FIG. 1 shows an example of an extractable tool according to some embodiments of the invention. Extractable tool 100 includes a nozzle 105, top plate 110, four foam blocks 115, core 125, and elastic bladder 130. Foam blocks 115 surround core 125. Top plate 110 can be placed over both core 125 and/or foam blocks 115. Top plate 110 can be coupled with nozzle 105 and/or with core 125. Foam blocks 115 can have any unique or intricate external shape.

The shape of foam blocks 115, for example, can be complementary to the desired shape of the composite structure being formed. For example, the external shape of foam blocks 115 can be the complement to a trapped shape.

Bladder 130 can be stretched over the outside of the core 125, foam blocks 115, and/or top plate 110. Bladder 130 and nozzle 105 can be sealed together to provide a sealed bladder that surrounds the other components. Bladder 130 can be made from an elastomeric material and/or any material that can accommodate high deformations experienced during tool extraction and/or any elastic material. Bladder 130 can be pressure-tight so that the extractable tool 100 can be pressurized or depressurized during various stages of the composite fabrication process. In some embodiments, a thin, commercially available silicone rubber can be used as the elastic bladder 130. Various other elastic materials can be used. Bladder 130 may also include a thin film coated on the exterior of foam blocks 115 or an integral skin formed during the fabrication of the foam.

Core 125 can be a simple, rigid (non-deformable) component located at the core of extractable tool 100. Several vent holes can be located along core 125 to provide open passages for the flow of air, which can allow extractable tool 100 to be pressurized or evacuated during various stages of the composite fabrication process. Core 125 can include a simple shape and construction, regardless of the complexity of the composite part for which it is intended. The surrounding foam blocks 115 can be machined to accommodate the contours, shapes, and other design features of the composite part. In some embodiments, a standard core 125 can be used for many different applications falling within a general size range.

Foam blocks 115 can be an arrangement of individual foam blocks made from any open celled, low density form. Foam blocks 115 can be produced in blocks and can be precisely machined to complex shapes. Foam blocks 115 can be rigid at ambient temperatures and can be capable of supporting typical lay-up loads without deforming. In some embodiments, foam blocks 115 can have a stiffness to allow for use with typical automatic tape placement and/or automatic fiber placement equipment. Foam blocks 115 can include materials that, when heated to temperatures near or above the glass transition temperature, can become flexible and capable of high levels of deformation and/or volume reduction. This can allow extractable tool 100 to be extracted from tortuous paths, small openings, overhangs, trapped configurations, or the like. In some embodiments, foam blocks 115 can recover its shape when reheated without constraint so that foam blocks 115 can be used repeatedly in the manufacture of multiple composite parts. In some embodiments, a combination of foam blocks and SMP foam blocks can be used.

The corner portions or blocks of extractable tool 100 can have a greater applied force from bladder 130 than other portions of extractable tool 100. To account for this force difference yet allow for uniform compression, the arrangement of foam blocks 115 can have a stiffness profile that varies from foam block to foam block. In some embodiments, foam blocks 115 can include a plurality of foam blocks having different stiffness coefficients. That is, foam blocks 115a-115i can have stiffness coefficients that vary from foam block to foam block. For example, the foam blocks on the corners 115a and 115i can have a stiffness coefficient greater than the foam blocks on the interior 115b-115h. The stiffness coefficient of the next interior blocks 115b and 115h can have stiffness coefficient greater than the stiffness of the remaining interior blocks 115c-115g. The stiffness coefficient of the next interior blocks 115c and 115g can have stiffness coefficients greater than the stiffness coefficients of the remaining interior blocks 115d-115f. The stiffness coefficient of the next interior blocks 115d and 115f can have stiffness coefficients greater than the stiffness coefficients of interior block 115e. Various other arrangements of foam blocks with different stiffness coefficients can be used. Furthermore, various arrangements of foam blocks with different stiffness coefficients can be used for any number of tooling shapes or configurations. In particular, in some configurations, foam blocks that are disposed or located at or near corners of a foam block assembly can have a greater stiffness than other foam blocks.

Nozzle 105 can be coupled with bladder 130 and/or configured to couple with a vacuum pump and/or a compressor to pressurize or depressurize bladder 130. In some embodiments, nozzle 105 can remain accessible throughout lay-up and/or cure processes of the composite part so that the appropriate hardware, such as pressure hoses, can be easily attached and detached as needed. Any type of pressurized nozzle can be used.

Extractable tool 100 can be used with any type of composite structure made from any type of composite materials using any type of process. For example, composite materials can include fiber reinforced polymers, carbon fiber reinforced plastics, glass reinforced plastic, fiber thermoplastics, thermoset composites, etc. Composite materials can be constructed using any type of polymer, for example, epoxy, polyester, vinyl ester, benzoxazine, and/or nylon. In some embodiments, composite materials can be reinforced with various components, for example, Kevlar, aluminum, glass fibers, and/or carbon fibers. Composite molding methods can include, for example, pre-preg, autoclave molding, co-curing, compression molding, resin infusion, resin transfer molding (RTM), vacuum assisted resin transfer molding (VARTM), SCRIMP, hand lay-up, vacuum bag molding, molding, etc.

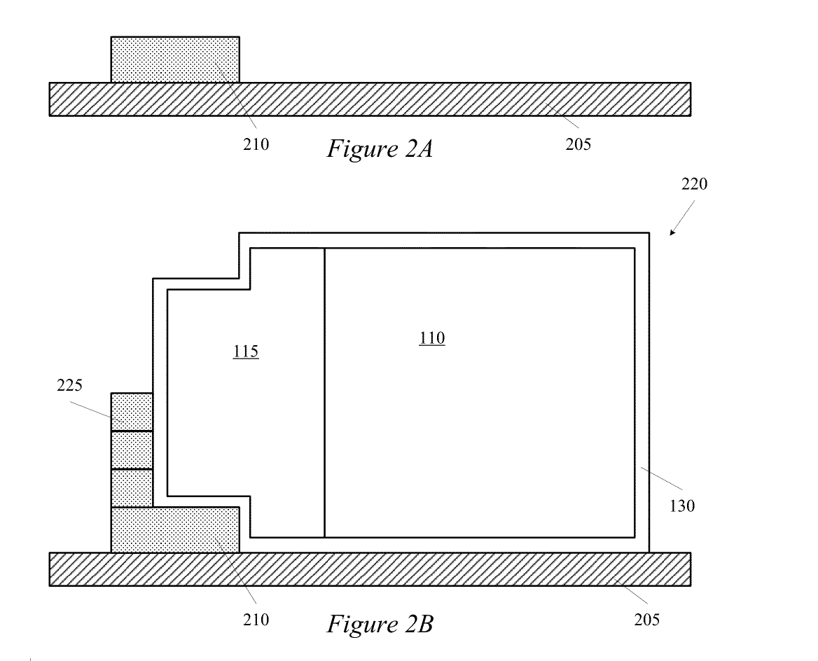

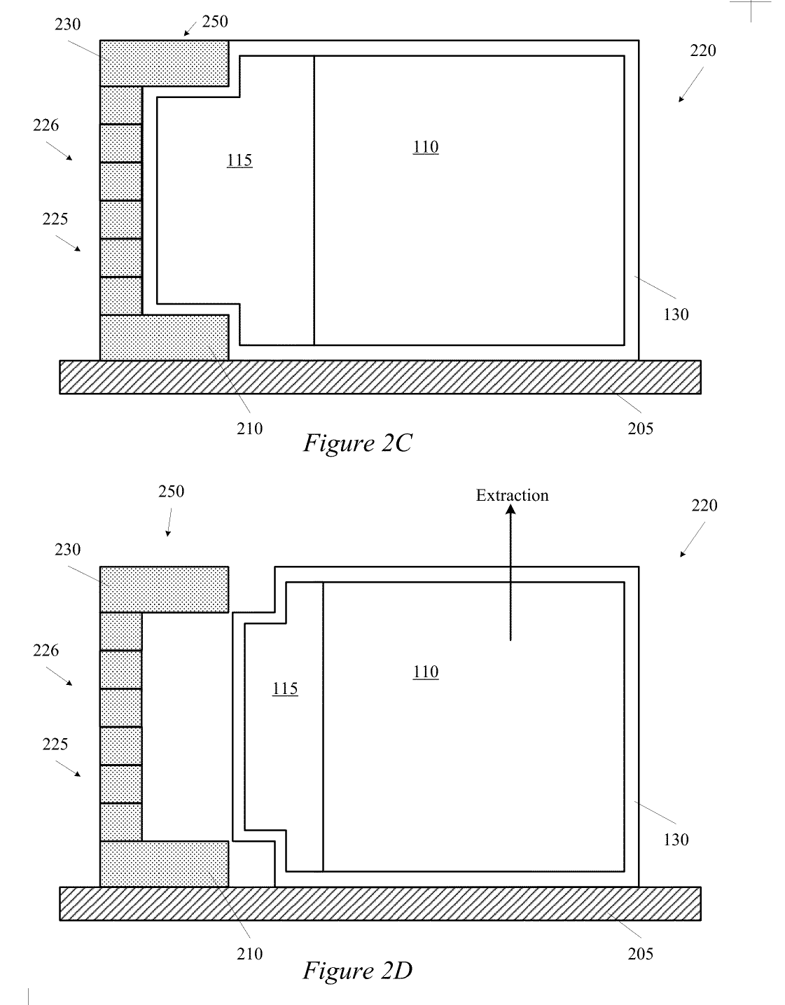

FIG. 2A shows a side view of the beginning of a process for building a composite structure. Layer 210 of composite material can be placed on substrate 205. In FIG. 2B, extractable tool 220 can be placed on substrate 205 and/or partially placed on first layer 210. In some embodiments, extractable tool 220 can be placed on substrate 205 prior to laying up first layer 210. Foam blocks 115 can have any shape such as the complement of the shape of the composite structure being built. Substrate 205 can include any surface. In some embodiments, substrate 205 can be a composite part of a full unitized structure. In other embodiments, substrate 205 can be a tooling device or mold.

FIG. 2B shows three composite layers 225 laid up against extractable tool 220. Foam blocks 115 can provide support to composite layers 225 while being laid up. The shape of foam blocks 115 can be complementary to the desired shape of the composite structure. Thus, foam blocks 115 provide a mold for laying up composite layers. While three composite layers 225 are shown, any number of layers may be used and they may have any thickness.

FIG. 2C shows a side view of composite structure 250 built on substrate 205 against extractable tool 220. As shown, more composite layers 226 have been laid up on composite layers 225. Top layer 230 has also been laid up overhanging extractable tool 220. Composite structure 250 forms a C-shaped structure. The C-shape and/or overhanging top layer 230 can cause extractable tool 220 difficulty in being extracted from the composite structure after manufacturing is complete. That is, composite structure 250 has a shape that traps extractable tool 220.

FIG. 2D shows a side view of composite structure 250 with extractable tool 220 being compressed prior to extraction from being trapped within composite structure 250. After composite structure 250 has been laid up and/or cured, extractable tool 220 may be heated to a temperature near or above the glass transition temperature of foam blocks 115. When foam blocks 115 have been heated above this temperature, they become rubberized. Air within bladder 130 can be evacuated through a nozzle (e.g., nozzle 105 in FIG. 1). The evacuation of air can cause the now rubberized foam blocks 115 to compress. This compression can allow extractable tool 220 to be extracted from being trapped within composite structure 250 as shown in FIG. 2D.

Various trapped-shape structures may require embodiments of the inventions. For example, structures that may have a trapped shape can include I-beams, C-beams, H-beams, double-T-beams, W-beams, rolled steal joists, L-beams, U-beams, etc. Combinations of these beam shapes may also be included. Furthermore, panels with multiple trapped beams, shapes, or configurations may also be present. Embodiments of the invention can be used or adapted for manufacturing of any type of structure with a trapped configuration. Structures may include unitized composite structures that include shells, skins, frames, longerons, stiffeners, beams, and/or other components in various configurations. Unitized composite structures are composite structures made from the same composite material without using fasteners (e.g., screws, bolts, rivets, etc.). Unitized composite structures can include structures with intersecting beams, longerons, and/or stiffeners. Multiple tool devices can be used to create unitized structures.

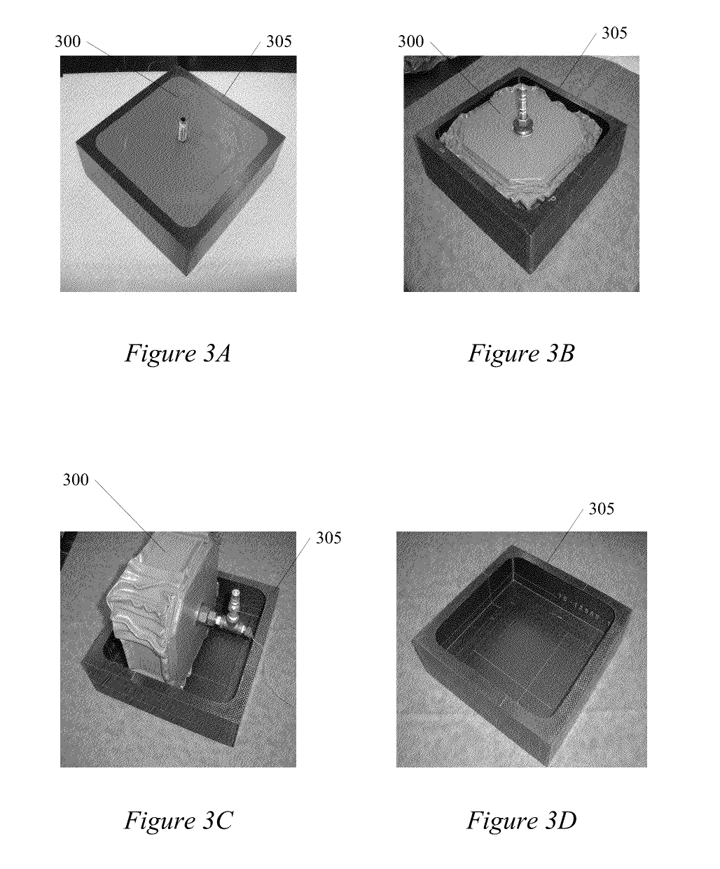

FIG. 3A shows photographs of tool 300 being extracted from composite structure 305. Composite structure 305 has been laid up around tool 300. After the lay-up process (and possibly curing), tool 300 is trapped within composite structure 305. During cure, positive pressure can be applied within the sealed foam tool, thus applying a consolidation pressure onto the composite laminate during cure much as pressure within an autoclave consolidates composite laminates during cure. That is, the formation of composite structure traps tool 300 with overhangs, concave portions, female portions, etc. Moreover, the composite structure conforms to the shape of the foam within tool 300. FIG. 3B shows tool 300 within composite structure 305 after compression of the foams. For example, tool 300 can become compressed when air is evacuated from tool 300. The compression is due to the foam within tool 300 compressing under vacuum (negative pressure) when heated to temperature near or above the glass transition temperature of the foam.

FIG. 3C shows tool 300 partially removed from within composite structure 305. As shown, once compressed, tool 300 is easily extracted from within the trapped shapes of composite structure 305. FIG. 3D shows composite structure 305 with tool 300 removed.

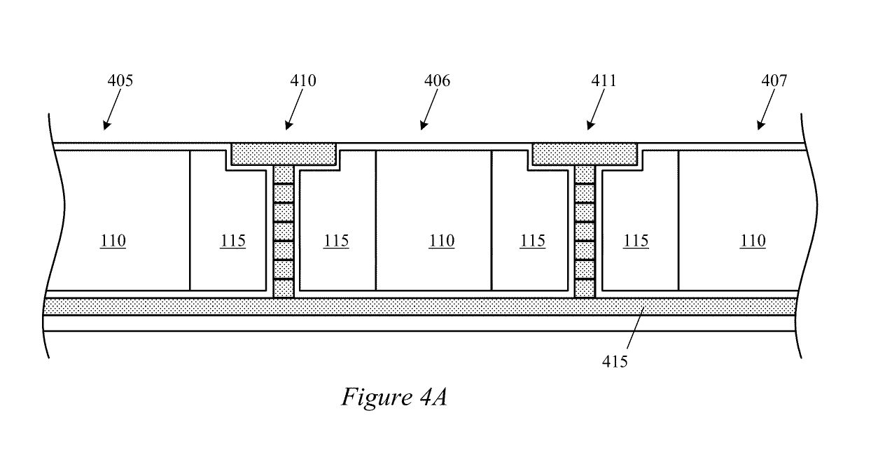

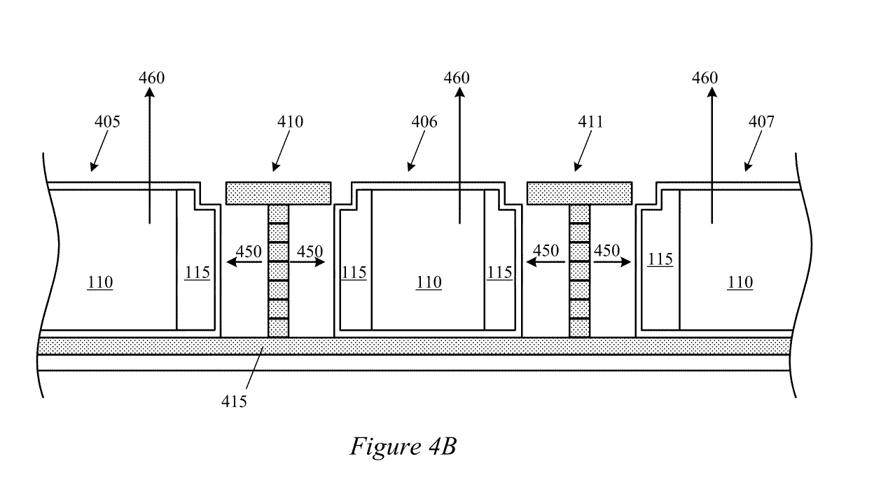

FIG. 4A shows three extractable tools 405, 406, and 407 that have been used to lay-up two composite T-beam structures 410 and 411 according to some embodiments of the invention. Tool 406 can include foam blocks 115 on both sides of core 125 for laying up both T-beams structures 410 and 411. Tools 406 and 407 can also include a plurality of foam blocks that are not shown. Moreover, tools 405, 406, and 407 can be three tools in a multidimensional array of tools being used to manufacture a unitized composite structure. In this embodiment, T-Beams 410 and 411 are laid up directly on skin 415. In this way, skin 415 and T-beams 410 and 411 can be a unitized composite structure. Positive pressure can be applied within the sealed foam tools that can be used to provide for appropriate consolidation of the composite laminates during cure, providing for a high quality composite laminate without use of an autoclave. FIG. 4B shows tools 405, 406, and 407 in a compressed state. After compression, tools 405, 406, and 407 can be extracted. As shown, the direction of compression of foams 450 can be transverse to the direction of extraction 460.

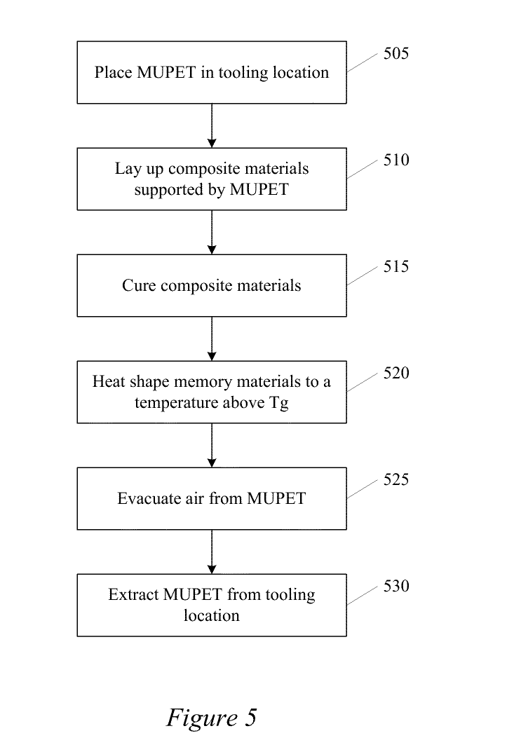

FIG. 5 is a flowchart of process 500 for using a tool according to some embodiments of the invention. At block 505, an extractable tool (e.g., tool 405, 406, 407, 300, 220, or 100) can be placed in a tooling location. This extraction tool can include foam(s) with various shapes and/or contours that are complementary to the shape of the structure being developed. A positive pressure can be applied within the tool to provide consolidation for the composite laminate.

At block 510 composite materials are laid up on or supported by portions of the extraction tool. In some embodiments, a positive pressure can be applied by the extraction tool during lay up. Composite materials can be laid up using any number of manufacturing techniques known in the art. A plurality of layers can be laid up in order to form the composite structure. In some embodiments, composite materials can be laid up in a configuration that traps the tool within the composite structure. In some embodiments, composite materials can form a concave, and/or overhanging shape trapping the extraction tool. At block 515 the composite materials can be cured.

At block 520 the tool can be heated to a temperature near or above the glass transition temperature of the foam within the extraction tool. Once the foam has reached temperature, air can be evacuated from the extraction tool, causing compression of the foam at block 525. Once compression has occurred at a level sufficient to allow the tool to be removed from being trapped by the composite structure, the extraction tool can be removed at block 530.

After extraction, the tool can be allowed to return to its original shape and/or configuration. This can be done, for example, by releasing the vacuum pressure from within the extraction tool bladder. Because of the flexibility and potential for volume change of foams and/or shape memory qualities of foams and/or SMP foams, the extraction tool can return to the original shape after being heated and depressurized. The extraction tool can then be reused as a mold for another composite structure.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A tooling device comprising:
a rigid core;
a foam block disposed next to the core and comprising a shape; and
a bladder surrounding the core and the foam block, wherein the bladder forms a barrier between an external environment and the core and the foam block.

2. The tooling device according to claim 1, wherein the foam block comprises a foam assembly including a plurality of foam blocks with a variety of different stiffness coefficients.

3. The tooling device according to claim 2, wherein the plurality of foam blocks are disposed next to or around the core.

4. The tooling device according to claim 1, wherein the foam block comprises a shape memory polymer (SMP), wherein the foam block is deformable at temperatures near or above a glass transition temperature.

5. The tooling device according to claim 1, wherein the shape of the foam block comprises a shape that is the compliment of a trapped shape.

6. The tooling device according to claim 1, wherein the foam block is stiff at temperatures below the glass transition temperature of the foam block.

7. The tooling device according to claim 1, further comprising a nozzle coupled with the bladder.

8. The tooling device according to claim 1, wherein the nozzle and the bladder form a pressure barrier between the external environment and the core and the foam block.

9. The tooling device according to claim 1, wherein positive pressure can be applied internally to the mold to provide consolidation pressure for the composite laminate during cure

10. The tooling device according to claim 1, wherein the core comprises a plurality of vent holes that provide passage for air.

11. The tooling device according to claim 1, wherein the stiffness of the foam block at room temperature comprises a stiffness to allow for use with an automatic tape placement device, vacuum assisted resin transfer molding processes, hand lay up processes, filament winding processes, or an automatic fiber placement device.

12. The tooling device according to claim 1, wherein the bladder comprises a thin membrane.

13. The tooling device according to claim 1, wherein the bladder comprises a silicon membrane.

14. A method for forming a composite structure, the method comprising:
positioning a tooling device in a workspace, wherein the tooling device comprises a foam material;
laying-up composite layers that are supported by the foam material;
curing the composite layers;
applying positive consolidation pressure in the mold during cure;
heating the foam material to a temperature near or above the glass transition temperature of the foam material; compressing the foam material; and
extracting the tooling device.

15. The method for forming a composite structure according to claim 14, wherein the foam material comprises a shape memory polymer foam.

16. The method for forming a composite structure according to claim 14, wherein the foam material comprises the compliment of a trapped shape that is a mold of the shape of the composite structure being formed.

17. The method for forming a composite structure according to claim 14, wherein the foam material comprises a shape that is a mold of the shape of the composite structure being formed.

18. The method for forming a composite structure according to claim 14, wherein the foam material is surrounded by a membrane that can be pressurized or evacuated allowing for consolidation of the composite laminate and compression of the foam.

19. The method for forming a composite structure according to claim 18, further comprising pressurizing with air or evacuating air from the tooling device.

20. The method for forming a composite structure according to claim 18, wherein positive pressure is applied that provides consolidation pressure on the composite laminate during cure.

21. The method for forming a composite structure according to claim 14, wherein the tooling device is compressed in a direction that is transverse to the direction the tooling device is extracted.

22. A tooling device comprising:
a solid core; and
a collapsible assembly surrounding portions of the solid core, wherein the collapsible assembly can be used to mold composites structures that have a trapped shape.

23. The tooling device according to claims 22, wherein the collapsible assembly comprises a shape memory polymer foam.

24. The tooling device according to claims 22, wherein the collapsible assembly is deformable at temperatures near or above a glass transition temperature.

25. The tooling device according to claims 22, further comprising a bladder surrounding the solid core and the collapsible assembly, wherein the bladder forms a barrier between an external environment and the solid core and the collapsible assembly.

26. The tooling device according to claims 22, wherein the collapsible assembly comprises a plurality of structures having different stiffness coefficients.
